(19) United States
(12) Patent Application Publication
(10) Pub. No.: US 2013/0085877 A1
(43) Pub. Date: Apr. 4, 2013

(54) INTERMEDIARY-BASED TRANSACTION SYSTEM

(71) Applicant: Andreas Rührig, Berlin (DE)

(72) Inventor: Andreas Rührig, Berlin (DE)

(21) Appl. No.: 13/250,393

(22) Filed: Sep. 30, 2011

(51) Int. Cl. G06Q 20/02

(52) U.S. Cl. 705/21; 705/39

(57) ABSTRACT

An intermediary-based, computer-implemented transaction-system for conducting transactions between entities connected via a social graph of a virtual social network is disclosed. The system includes at least one virtual social network platform storing social graphs connecting virtual entities, the virtual social network providing at least one virtual communication channel allowing the virtual entities to communicate with each other, at least one social graph includes a connection between at least one individual and at least one business partner. A transaction provider is configured to read-out the social graph and register the connection, and one or more mobile devices are configured to execute a transaction application provided by the transaction provider. The transaction application uses the registered connection to enable an individual to create a transaction with the business partner. A notification indicating the transaction is generated and transmitted to the business partner by triggering the at least one virtual communication channel.

### BACKGROUND

1. Technical Field

The present disclosure relates to methods, techniques, and systems for providing trusted transactions between individuals, and between individuals and business partners.

2. Description of the Related Art

Individual financial transactions, i.e., the transfer of money from one individual to another, are a key fundamental of today's economy. In general, these transactions are enabled by financial institutes, e.g., banks, financial service providers and/or credit card companies.

A prerequisite for any transaction in that sense is that the individual intending such a transaction has registered to an institution representing some financial service provider and has established an identity there. That identity allows the individual to create financial transactions to yet another individual and/or business partner. Such an identity may be for example a bank account, a credit card or the like.

In order to create a financial transaction, the individual generally has to disclose at least a part of that identity to a third party that the transaction is intended to be directed to. In the case of a bank transfer, the receiving end has disclosed its bank identity (for example, bank account number and the like) to the individual that intends to transfer money to the receiving individual. In other examples, e.g., when conducting transactions based on a credit card the individual owning the credit card and intending to transfer money has to disclose its credit card credentials to the receiving transaction partner, in order to enable the receiving partner to create a credit card payment or booking debited to the individual's credit card account.

Conducting financial transactions on that basis is more and more perceived as cumbersome and ineffective. This in particular applies for a transaction type that is most common and most frequently used: The transfer of small sums of money between numerous transfer partners.

While these transfers traditionally used to be based on money in cash, internet economy and its impact has changed preferences towards virtual money transfers. Based on the transfer of money via bank accounts and/or credit cards however, for any of these numerous transactions partners the account details must be know. This is of particular inconvenience as seldom such bank account and/or credit card details may be readily at hand.

Moreover, financial service providers issuing the credit cards and/or maintaining the banking account stress such small sum of money transfers with relatively high transfer fees. These are rendered usually on the basis of a percentage of the transferred sum (e.g., 3-4%) and an absolute minimum fee. In particular the later may render a small sum transfer as rather expensive and ineffective.

In addition, even when using these transfer methods despite their inconvenience and excessive costs, security or rather the preventing of fraud more and more becomes an issue: In former times, security in these transactions was, at least in part, assured by the necessity of presenting physical credentials during the transaction, for example providing a personal signature, presenting the physical credit cards or the like. In contrast to that, in transactions of today's internet economy such physical credentials are more and more omitted and replaced by other credentials, e.g., PIN code, credit card number and the like, which are frequently subject to virtual crimes and fraudulent use. This has lead to an enormous increase in fraudulent activities, such as for example phishing of credit card credentials or bank account identities. As a consequence, trust in conducting transactions is dramatically reduced and significant financial damage is created for businesses.

### BRIEF SUMMARY

The present disclosure relates to methods, techniques, and systems for providing trusted transactions between individuals, and also between individuals and business partners and, in particular, to methods, techniques and systems for employing connections between entities as represented in social graphs of virtual social networks to transmit financial transactions between an individual and a merchant at a point of sale.

The transactions are conducted between entities that have a virtual identity in one or more virtual social networks. A transaction application provided by a transaction provider connects to a virtual social network and imports the connections stored in the virtual social network as a social graph of an entity registered with the virtual social network.

Based on the registered transaction, one entity may initiate a transaction to a target entity by executing on a mobile device a transaction application provided by the transaction provider, generating a notification to the target entity that represents the transaction and triggering the virtual social network to transmit the notification to the target entity via any of the virtual communication channels provided by the virtual social network.

### BRIEF DESCRIPTION OF THE SEVERAL VIEWS OF THE DRAWINGS

FIG. 1 schematically shows an intermediary based transaction system.

FIG. 2 schematically shows an example of a graphical user interface for a transaction application.

FIG. 3 schematically shows a private-to-business transaction system.

FIG. 4 schematically shows an example sequence diagram of an intermediary based transaction between an individual and a business partner.

FIG. 5 is a functional block diagram of an embodiment of a computing system suitable for use in an intermediary-based transaction system.

### DETAILED DESCRIPTION

Embodiments described herein provide computer- and network-based methods, techniques, and systems for providing trusted transactions between individuals, and also between individuals and business partners and, in particular, to methods, techniques and systems for employing connections between entities as represented in social graphs of virtual social networks to transmit financial transactions between an individual and a merchant at a point of sales.

In at least one example embodiment, an intermediary-based, computer-implemented transaction-system for conducting transactions between entities connected via a social graph of a virtual social network is provided. As part of this system, at least one virtual social network platform stores social graphs connecting virtual entities of individuals and business partners, the virtual social network providing at least one virtual communication channel allowing any of the virtual entities to communicate with each other, and the virtual social network storing at least one social graph comprising a connection between at least one individual and at least one business partner. As an second part, a transaction provider is enabled to read-out the stored social graph and registers the connection. As a third part of the system, one or more mobile devices are provided that are configured for executing a transaction application provided by the transaction provider. The transaction application employs the registered connection to enable the at least one individual to create a transaction to the at least one business partner using the transaction application, such that a notification indicating the transaction is generated and transmitted to the at least one business partner by triggering the at least one virtual communication channel.

In at least one example embodiment, the notification is transmitted substantially in real time. In at least one further example embodiment, the mobile device is at least one of a smart phone, a laptop, a tablet, or a desktop computer. In at least one example embodiment, the business partner is a merchant at a local point of sales. In at least one example embodiment, the business partner is a further individual. In at least one example embodiment, the reading-out of the social graph comprises connecting by the transaction application to the virtual social network using the individual's login to the virtual social network, reading-out the social graph of the individual, and importing all connections represented with the read-out social graph. In at least one example embodiment, the transaction application employs a positioning capability of the mobile device to enable the individual to indentify the merchant using a location based service of the transaction provider.

In at least one example embodiment, a method is provided for performing the actions of any of the above described techniques. In at least one example embodiment, a computer-readable medium is provided having stored thereon contents, for example, computer-readable instructions that, when executed on a computer, are configured for performing the actions of any of the above described techniques.

The computer-readable medium may be, for example, a non-transitory computer-readable memory means communicatively coupled to a computer system, which stores the computer-readable instructions. In other example embodiments, the computer-readable medium may include for example, computer-readable transmission mediums, including wireless-based and wired/cable-based mediums which store and/or transmit signals containing computer-readable instructions for performing the actions of any of the above described techniques.

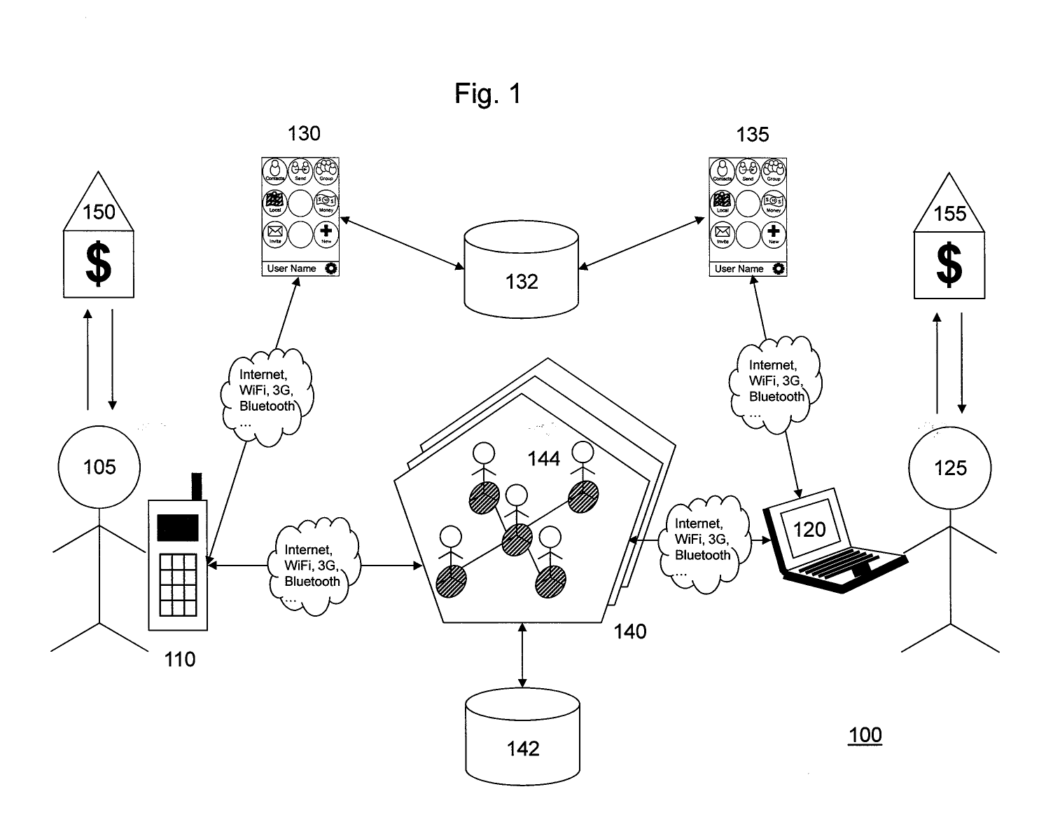

FIG. 1 schematically shows the intermediary transaction system 100 that allows individual 105 to execute a financial transaction with individual 125. FIG. 1 shows as a part of the intermediary based transaction system 100 a virtual social network 140 that conveys social graphs 144 of the members of the social network 140, namely individuals 105/125, which are stored in database 142. Moreover, as a further part, FIG. 1 shows computing devices 110, 120 which may represent for example mobile phones, smart phone, laptops or other computing devices like pad based computers, desktop computers or terminals. Furthermore, the intermediary based transaction system 100 has further parts showing financial service providers 150, 155 and transaction application 130, 135 which may be adapted, for example, to one or more specific form of computing device 110/120.

Virtual social network 140 as an intermediary maintains memberships, or in other words virtual identities or virtual entities, representing various individuals 105, 125 which are connected to each other in form of a social graph 144. Social graph 144 stores connections between virtual entities being registered at virtual social network 140. Thus, each virtual entity being connected via social graph 144 is created on the basis of an account of individual 105/125 at virtual social network 140.

Social graph 144 may be established by virtual expressions of sympathy (for example “like” button in case of the example of social network “Facebook”), or may be based on a historic pattern of communication, i.e., individuals 105, 125 communicating with each other using a virtual communication channel, like for example electronic mail. It may be based upon the acceptance of the exchange of contact details that enables further direct communication (for example in chat based communication channels, like for example, Skype/instant messaging) or may be based upon any other form of linking individual profiles, contact details or virtual identities or entities representing individuals 105/125 to each other. Via the provider of the virtual social network 140 between the members of the social graph 144, a communication channel is established that allows individuals 105, 125 and members of social network 140 to communicate with each other directly, and in electronic form, via the services provided by the platform of the virtual social network 140. In one example this virtual social network 140 for these purposes provides virtual communication channels to registered users that allow for communicating amongst the users substantially in real time. In one example, virtual social network 140 provides an application that uses the social graph 144 stored in database 142 to allow individuals 105/125 to connect to each other and communicate with each other in various forms using the platform provided with the social network 140.

In order to get access to and use social network 140, individuals 105/125 in one example use computing devices as indicated in the intermediary based transaction system 100 with devices 110/120. Although in FIG. 1, it is indicated that these computing devices 110/120 are represented as a mobile phone 110 and a laptop 120, any suitable computing device, mobile phone, smart phone and desktop computers or terminals allowing access to the internet or other network may be used to connect individuals 105/125 as indicated in FIG. 1.

Thus, the specific form of the computing devices 110/120 as well as the number of individuals and/or number of computing devices is not limited to the specific form and/or specific number of computing systems as shown in the example of FIG. 1. In contrast, various methods of heterogeneous and homogeneous computing systems may be used and distributed in other manners in order to implement embodiments of the disclosure.

In an example embodiment, the computing devices 110/120 and servers 142 may be implemented on general or special purpose computers or computing systems. These computing systems may be implemented in software, hardware, firmware, or in some combination thereof. One or more of them may include one or more central processing units (CPU'S), input/output (I/O) devices, memory or other computer-readable media, and one or more network connections.

Also, some or all of the components may be implemented or provided in other manners, such as at least partially in firmware and/or hardware, including, but not limited to one or more application specific integrated circuits (ASIC's), standard integrated circuits, controllers (e.g., by executing appropriate instructions, and including micro controllers and/or embedded controllers), field-programmer gate arrays (FPGA's), complex programmer logic devices (CPLD's), etc.

Some or all of the system components and/or data structures may also be stored as content (e.g., as executable or other machine readable software instructions, or structured data) on a computer-readable medium such as a hard disk, a memory, a network or a portable media article to be read by an appropriate drive or via an appropriate connection. Some or all of the system components and data structures may also be stored and/or transmitted as content of generated data signals (e.g., by being encoded as part of a carrier wave or otherwise included as part of analogue or digital propagated signal) on a variety of computer-readable transmission mediums, including wireless-based and wired/cable-based mediums. It may take a variety of forms (e.g., as part of a single or multiplexed analogue signal or a multiple discrete digital packets or frames). Such computer program products may also take other forms in other embodiments. Accordingly, embodiments of this disclosure may be practiced with other computer system configurations.

In the example of FIG. 1, individual 105 creates, while accessing the internet via computing device 110, an account within social network platform 140 which is stored as an entity representing individual 105 on database 142. Based on that account, individual 105 can connect to other individuals thereby establishing a social graph 144 that represents the various connections that end at and/or originate from the entity in database 142 representing individual 105, in other words the virtual identity of individual 105 in social network 140.

While in the example of FIG. 1, one social network platform 140 as well as one social graph 144 is depicted. In other examples, individuals 105/125 may be connected to various, and in particular more than one social network 140, and may be part of various, and/or alternative social graphs 144 stored in various databases 142.

Furthermore, the example of FIG. 1 shows transaction applications 130, 135 that are accessed and used by individuals 105/125 via computing devices 110/120 amongst others for the purpose of conducting financial transactions. As the computing devices 110/120 may take on different forms, also a computing application 130/135 may have different formats adapted to the various operating systems/computing platforms of computing devices of 110/120 providing in each of these adapted forms at least similar functionality.

In an example, application 130/135 provides various functions to its users 105/125 namely maintaining a list of contacts, a transaction generation functionality, an account overview functionality, a capability to use location based services for creating transactions and functionalities for inviting friends, changing account details and the like.

In one example, users 105/125 may get access to transaction application 130/135 by registering with the virtual transaction provider 132 that provides e.g., via download or any other means, application 130/135 adapted to the computing device 110/120 used by individual 105/125. While registering to the virtual transaction provider 132, individual 105 may provide details of a bank account or credit card registered with financial service provider 150 or may alternatively create a virtual electronic wallet with transaction provider 132 and pre-load this e-wallet with some amount of money.

After having registered with transaction provider 132, individual 105/125 connects its identity, or in other words its account, at transaction provider 132 with the social networks 140. In other words, the account of individual 105/125 at social network 140, such that via application 130 the social graph 144 that individual 105 is a member of can be read out from platforms 140 or rather databases 142. In one example, this activity is performed by the individual 105 indicating to transaction application 130 its account credentials of individual's 105 account at social network 140. In that example, in response to that, transaction application 130 employs the credentials to log onto social network 140, analyses the entity of social network 140 representing individual 105, in response to that identifies the connections representing the social graph of individual's 105 social network account and import all connections present in social graph 144 to be available for use by individual 105 via transaction application 130.

Thus, after having registered and connected with transaction application 130 to transaction provider 132, individual 105 is able to identify within application 130/135 any contact that individual 105 is connected to via social graph 144, in any virtual social network platforms 140 that individual 105 is a member of. More particularly, in an example shown in FIG. 1, individual 105 is able to identify via application 130 individual 125, as individual 105 and individual 125 are connected via at least one social graph 144 provided with at least one social network platform 140.

Thus, based on the connection established within application 130/135, individual 105 registered with transaction provider 132 may now transfer any amount of money to individual 125 via application 130/135. In one example, individual 105 for that purpose starts application 130 on mobile phone 110 and searches individual 125 via a contact list functionality of application 130. After having identified individual 125 in the contact list of application 130, individual 105 inputs any amount of money to be transferred to individual 125 via transaction provider 132 by inputting the amount and confirming the transaction using credentials provided to the individual 105 during the registration procedure at transaction provider 132.

In response to that confirmation, application 130 triggers at least one platform 140 or several platforms 140 to generate a message, via the platform specific communication channel, to indicate to individual 125 that a financial transfer from individual 105 to individual 125 is intended. In case individual 125 has also been registered to transaction provider 132 and uses application 135 via laptop 120, the account overview functionality of application 135 indicates to individual 125 that money has been added to individual's 125 account.

However, in case individual 125 is not yet registered with transaction provider 132, the message provided to individual 125 via social network 140 will contain not only the indication that a financial transfer is intended, but in one example, an additional indication that for receiving the money, individual 125 should register with transaction provider 132.

In one example, a link may be provided with the message that enables individual 125 to access via computing system 120 directly, the registration procedure at transaction provider 132. As application 130/135 triggers the proprietary communication channels of platforms 140, messages indicating respective transactions between individuals 105/125 being members of the same platform 140 and being connected via one social graph 144 will be transmitted substantially in real time. Thus, in contrast for example to a bank transfer, money transfer based on the intermediary based transaction system provided with transaction provider 132 is executed substantially quicker.

Moreover, even if individual 125 in case of such transaction is not yet registered with provider 132, based on the read out social graph 144 available to application 130 after the registration of individual 105, enough information about individual 125 is present at transaction provider 132 to allow individual 125 to register with transaction provider 132 by just the confirmation of the registration. Only in case of the need to register for the bank account or other individual details, individual 125 may enter the automatically created user account at transaction provider 132.

Thus, transaction provider 132 enables financial transactions between individuals 105/125 using virtual social networks as intermediaries for the case that individual 125 is also registered with transaction provider 132 but also in fairly convenient form in case individual 125 has not yet registered with transaction provider 132.

In the example of FIG. 1, transaction system 100 thus highlights the role of transaction providers 132 and virtual social network platforms 140 as intermediaries in executing transactions between individual 105/125.

For example, instead of disclosing individual's 125 identity (e.g., account and the like) at financial service provider 150, individual 105 instead connects to individual 125 in a trustworthy way based on a privacy ensuring social network provider 140. In a further layer of privacy protection, transaction provider 132 enables individual 105 to use this established connection in social graph 144 for the purpose of transactions, for example money transfers, without any need to disclose or input any credit card credentials, bank account information and the like. In contrast, individual 105 is enabled by transaction service provider 132 to identify individual 125 via the transaction application 130, and to initialize a money transfer to individual 125 which is moderated and secured by transaction provider 132 without any transfer of bank account details, credit card credentials or the like. As none of this information is disclosed nor transferred during the transaction, any fraud of transaction system is prevented and the level of security of such transactions is significantly increased.

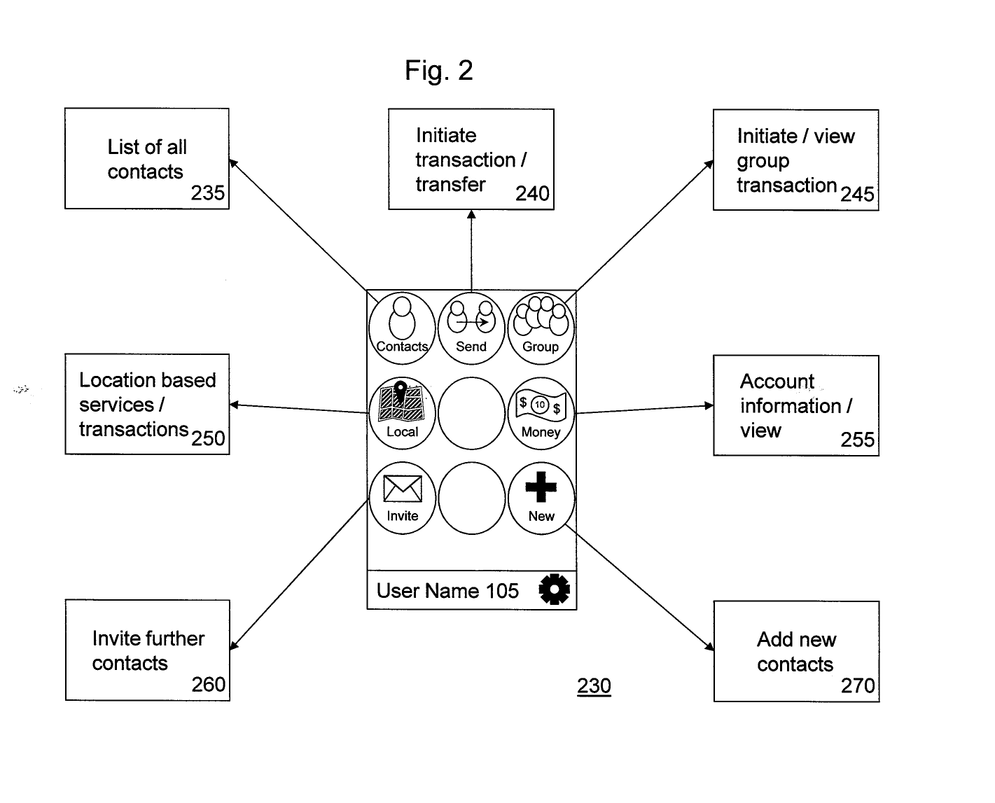

FIG. 2 shows an example of the transaction application 230 which may be executed on any computing device 110/120. More particularly, FIG. 2 shows an example of an user interface 230 with exemplary functionality of maintaining a contact list 235, creating a financial transaction 240, creating group transactions 245, using location based services 250, maintaining an account overview 255, inviting further contacts 260, and adding further contacts 270. However, the specific appearance and further the number and kind of functionality shown in the example of FIG. 2, are of rather exemplary character and thus further embodiments may show different/alternative appearances, may comprise additional/alternative functionality and enable alternative or further actions when using application 230.

In the example shown in FIG. 2, function 235 enables individual 105 to maintain a list of contacts. The contacts may have previously been imported by individual 105 into transaction application 230 based on connecting to individual's 105 account with social network 140.

In an exemplary embodiment, this list of contacts may be filled based on reading out the social graphs 144 of the virtual social networks 140 that individual 105 is connected to. For that purpose, functionality 235 may enable individual 105 to choose from a list of social network providers 140, those providers 140 that individual 105 is registered with, enter the respective login credential and confirm to add the members of individual's 105 social graph 144 stored at the chosen social network provider 140 to the list of contacts. In one example embodiment, at the same time these imported contacts are invited to also register with transaction provider 132.

In addition, individual 105 may add further contacts to the list of contacts 235 using functionality 270. The functionality 270 of contact adding may enable individual 105 to add further contacts using individual contact details of individual 125, like for example, an email address, a mobile phone number or other kind of electronic contact details.

Thus, based on the list of contacts 235 that individual 105 has created in its account at transaction provider 132, transaction provider 132 can read out available connections between 105/125 based on social graphs 144 stored in databases 142 of virtual social network providers 140. In other words, based on individual 105 choosing one or more social network providers 140 from a list of social network providers 140 presented with functionality 235, the transaction application 130 can use individual's 105 login credential to one or more of the chosen social networks 140 to log into these social networks 140. Transaction application 130 will then read out the respective social graphs 144 to identify social network links between individual 105 and one or more individuals 125, which are accordingly added by application 230 to the list of contacts 235 of individual 105.

Using any of the contacts listed in contact list 235, individual 105 may choose to transfer money to any of these individuals 125 using functionality 240. The money sending functionality 240 of application 230 allows individual 105 to choose any one individual 125 from the list of all contacts 235, and to specify an amount of money to be transferred to that individual 125.

In one example embodiment, the money transaction is confirmed by individual 105 with confirmation credentials provided to individual 105 during the registration procedure from transaction provider 132. These confirmation credentials may be, for example, a login name and password or can alternatively or additionally be any other credential, like for example a PIN number, a secret code or the like.

Thus, individual 105, in order to transfer money to individual 125, can now access transaction application 230 via any mobile computing device 110 or any internet terminal 120 and use the thereby accessed transaction application 230 to transfer money in a trusted way to individual 125. The security of such a transaction is significantly increased since for performing such transaction individual 105 may not need to enter any financial service provider 150 identity like for example, bank account details or credit card credentials.

Moreover, the convenience of such transactions is significantly increased since application 230 may be used from any device regularly available to individual 105, for example a smart phone 110 or a laptop 120. By accessing transaction application 230, via for example smart phone 110, it is sufficient for individual 105 to identify a transaction target in contact list 235, enter any amount of money and confirm the transaction to transfer money to individual 125. Thus individual 105, for the purpose of an intended money transaction, is not obliged to know any financial service identity of individual 125 for example, individual's 125 bank account details, but can transfer money to individual 125 just on the basis of being connected to the individual via a social graph in virtual social network 140.

When generating a transaction via functionality 240, in one example embodiment individual 105 may add to the transaction additional information that is transferred to individual 125 together with the notification that a money transfer has been created. In contrast to traditional bank account transfers, this text message may be of unlimited length allowing further the adding of media files, for example movies, pictures and the like.

The notification generated in response to the confirmation of the transaction by individual 105, is in one example, sent by the transaction application 230 triggering the respective communication channel of virtual social network 140 that provided the specific link or connection between individual 105/125, that has been used by transaction application 232 to add individual 125 to the contacts list of individual 105.

In one example, individual 125 may have been added to contact list 235 of individual 105 by individual 105 choosing in transaction application 230 from a list of social networks 140 the specific social network “Facebook”. In that case, when later transferring money to individual 125 the transfer notification generated by functionality 240 may thus trigger the proprietary communication channels of social network “Facebook” that has provided the link between individual 105/125 to transfer the notification generated by transaction application 230 to individual 125.

Thus, transaction application 230, via the functionality 240, triggers the proprietary electronic communication channels of various virtual social networks 140 to transfer notifications of an intended money transfer from individual 105 to individual 125. Using this triggering mechanism and message transfer via social networks 140, both convenience and security of the money transaction is increased. More particularly, by using the proprietary communication means of social networks 140, transaction application 230 may ensure that transaction notifications from individual 105 to individual 125 are transmitted substantially in real time. Individual 125 may be notified, just a few seconds after individual 105 has confirmed the transaction, that such a transaction has been confirmed and money is intended to be transferred to individual 125.

Moreover, as transaction application 230 triggers social networks 140 to create transaction notifications, it is possible to avoid creating an electronic communication that is less likely to be subject to hacking, phishing and the like. Instead, for transferring transaction notifications from individual 105 to individual 125 proprietary, well-protected communication channels are used that usually are of higher security than standard electronic communication channels. However, in case such notification would be hacked, or by accident, observable by any third party the transaction itself stays protected from fraudulent interceptions as the notification just represents a notification. In other words, by observing the notification, no means become available to intercept that transaction provided by transaction provider 132 to re-route the money transferred in a fraudulent manner to any third party account.

For the case, that individual 125, being the target of the transaction initiated by individual 105, is not yet registered with transaction provider 132, the notification triggered via social network 140 may also contain a link to a registration procedure/functionality provided by transaction provider 132. Moreover, in case individual 125 was not added to the contacts list via functionality 235 and the reading out of social graph 144 from social network providers 140, but instead by using functionality 270 and adding an individual 125 based on the individuals mobile number and/or email address, similar notifications are sent via the communication channels (short messaging services using a mobile number, email using an email address and the like) provided with the contact details of individual 125 as being added using functionality 270. In that instance, individual 225, in case of a money transfer, similarly receives a notification stating the amount of money to be transferred, an explanatory text message input by individual 105 and further information regarding how to create a new account with transaction provider 132 to get access to the account at transaction provider 132 that the money from individual 105 has been transferred to.

After having confirmed a money transaction or received a notification of a money transaction, individual's 105 account in transaction application 230 is altered accordingly. Information on that account can be viewed by individual 105 through functionality 255.

In one example, functionality 255 provides an account overview to individual 105 such that a list of transactions is provided with respective metadata. The metadata may, for example, include a date of transaction, a date of notification, explanatory transaction information, a location of the transaction, and together with any amount an indication of whether it was a debit or a credit booking.

Furthermore, the list of transactions may be selectable by the individual 105 to show only specific transactions based on categories of the metadata. For example, individual 105 may select to only show private to private transactions, private to business transactions, group transactions, and incoming or outgoing transactions. Similarly, individual 105 may choose to select a list of bookings based on status information, such as transactions still to be received, transactions that have already been received, transactions that have been accepted and transactions that have been declined. The latter status information, in one example, may be generated based on group transactions that are generated using functionality 245 provided by transaction application 230.

With the group transaction functionality 245, individual 105 is enabled to create and join group transactions where a group of individuals join to perform a group buy, for example, for a birthday gift. In one example, when individual 105 may create such a group transaction via functionality 245, individual 105 may add further individuals 125 to the transaction and an amount of money to be received by any of these individuals 125 to that transaction. In response, group functionality 245 makes such a group transaction by listing the individuals 125 with their money amounts and associated status in terms of the amount having been transferred. The status would read “received” if the amount has been successfully transferred, or “receivable” if the amount is still outstanding.

Moreover, individuals 125 that have been added by individual 105 to such a group transaction may be provided with the opportunity to accept or decline their membership to such a group transaction. Thus, any individual having been added by individual 105 with a money amount to such a group transaction may further have a status of “accepted” if the individual 125 has accepted its membership to the group transaction, or the status of “declined” if the individual has not accepted its membership to the group transaction.

Transaction application 230 further may provide functionality 250 that enables money transactions as a location based service. More particularly, in one example, in contrast to a transaction between two private individuals 105/125 in addition the transaction application 230 may enable private-to-business transactions, for example at a local point of sales.

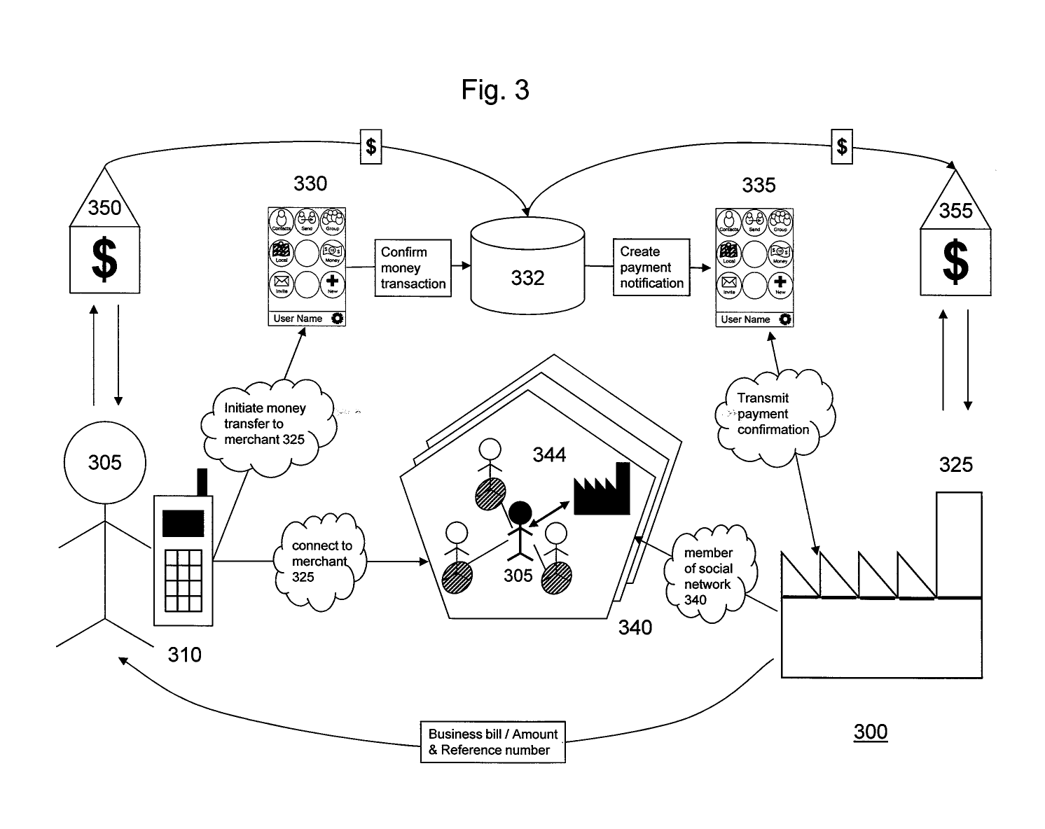

FIG. 3 shows an example of an intermediary based transaction system 300 that enables transactions between individual 305 and a local business owner 325, namely a merchant 325. In the example shown in FIG. 3, as outlined above, individual 305 is registered with transaction provider 332 and runs transaction application 330 on some kind of mobile computing device 310/320.

In one exemplary scenario, when shopping at a local store and in order to pay for the purchase, a user starts transaction application 330 on mobile device 310 and may first, for example, check the account overview 255. In that example, account overview 255 indicates that the current account balance is sufficient to pay the purchase. In that case, or otherwise, user 305 may search via functionality 250 the current local shop using location based services such as for example identifying the current location using a GPS location. The user may then search the address book 235 of transaction application 230 for the particular store, checking favorites in location based services 250 for the particular store, or searching using any social network provider 340 for the particular store with our without using the current positioning provided, for example, by mobile device 310 to reduce the number of business locations offered.

For example, when using location based services by connecting via mobile device 310 to a particular social network 340, and searching there on the basis of the identified location (e.g., based on GPS coordinates or identification) and/or name of the current store, the particular store location and/or a focused list of potential stores can be offered when individual 305 selects the particular store it is currently shopping in.

In addition and/or alternatively, individual 305 may use transaction application 230 and/or any social network 340 to identify the particular store using key word and/or name search or the like. In addition and/or alternatively, in case individual 305 may have been at the store 325 before, the particular store 325 may also be found by individual 305 within a list of favorites stored in the contacts list 235 and/or the location based services functionality 250 of transaction application 230.

Having identified the particular location 325, individual 305 would be provided with additional information on the particular location 325 for example, general information on the store 325 and location, a map highlighting the position of the location 325 and/or pictures showing the location 325. Thereby, individual 305 will be able to unambiguously identify the particular shop 325 where a purchase is currently to be paid.

After having identified the particular location 325 from a list of merchant locations that is presented in response to a search, for example based on address book, favorites or location based services, a status is indicated in transaction application 230 which highlights whether or not that particular merchant location 325 is connected to individual 305 in any social graph 344 of any virtual social network 340.

In case individual 305 has not yet been connected with merchant location 325, individual 305 is prompted by transaction application 230 to connect with merchant location 325 using at least one of potentially several social networks 340 offered for establishing such connection via transaction application 330. In one example, an individual 305 may choose, for example, to connect to merchant location 325 activating a “Facebook” connecting function “like”. Based on that, at least in one social graph 344 of at least one social network 340 the individual 305 and merchant location 325 are connected.

This established connection may now be used by transaction application 230 to convey a money transfer from individual 305 to merchant location 325 in order to pay the bill for the current purchase.

For that, individual 305 uses functionality 240 of transaction application 230, creates a money transfer choosing merchant location 325 as a target, enters the amount of the current purchase, and adds some explanatory message to help the merchant 325 to identify the payment of the current purchase bill. In other examples, besides paying the amount of the bill, a user 305 may be enabled, by transaction application 330, to add a use fee to the amount using a slider that indicates percentages added to the sum of the purchase. In further examples, besides or as an alternative to the explanatory text of the money transfer notification, a user 305 may be enabled by transaction application 330 to add a reference number of the bill to be paid.

After having confirmed the money transfer from individual 305 to merchant 325, individual 305 may be prompted to post a commentary on the purchase experience at that specific merchant location 325 to the social network 340 that connects individual 305 with merchant location 325. Additionally, individual 305 may be prompted to add merchant location 325 to individual's 305 favorites in location based functionality 250 of transaction application 230.

As transaction system 300 employs virtual social network 340 to enable money transfers between individual 305 and merchant 325, connections between individuals 305 and a particular merchant 325 are conveyed. Thus, based on the transactions conducted via transaction system 300 any merchant 325 is supported in building connected groups of costumers 305 via social networks 340. Based on that, transaction system 300 not only provides a system for conducting payment transfers but also acts for merchant 325 as a customer loyalty system ensuring to add more and more customers 305 of merchant 325 to a growing virtual group connected via social network 340.

This enables merchant 325 not only to process transfers with customers 305 being currently present at the point of sale 325. In addition, merchant 325 may conduct several customer loyalty schemes via transaction system 300: In one example, merchant 325 may create a number of bonus coupons that may be redeemed at point of sales 325. Based on transaction system 300, merchant 325 may create such coupons in a controllable, trusted and electronic way. In one example, the number of coupons may be defined as a credit added to the account balance 255 of individuals 305 connected to merchant 325. In case any of these customers 305 enter shop 325, at paying of the purchase, this bonus credit may be automatically subtracted from the amount to be paid.

In that example, transaction system 300 allows merchant 325 to post bonus coupons via social networks 340 to a defined group of individuals 325 that may use these bonuses only in the controlled way provided by transaction application 330 and transaction provider 332. Thus, any bonus coupon may be published specifically for a particular point of sales 325, be valid for a defined period of time (from . . . until . . . ) that is controlled via transaction provider 332 and be dedicated to a defined group of people (i.e., individuals 305 being connected to merchant 325) with or without enabling the option to pass over that bonus coupon to any other individual being registered with transaction provider 332. That way, again transaction provider 332 act as a guarantor of the security of such loyalty scheme preventing any fraudulent use of such bonus coupons based on the trusted workflow of the system 300.

In one example, in response to confirming the money transfer by individual 305 using functionality 240 of transaction application 230, and using confirmation credentials received during the registration procedure at transaction provider 332, transaction application 330 or transaction provider 332 triggers the virtual social network 340 that connects individual 305 with merchant location 325 to generate a message using the social network's 340 proprietary communication channels. The message indicates to merchant 325 that a money transfer has been executed, the transfer originating from individual 305 and referencing a current transaction at the location of merchant 325.

In another example, that message may contain at least information about the confirmed amount of money and an explanatory text. In other examples, the message may further contain a location 325 that indicates where the referenced purchase has been executed for which the money transfer has been confirmed, in order to confirm that the transfer has been made from the specific customer 305 that is currently in merchant location 325 and/or the notification message may contain some reference number of the bill to be paid at merchant 325.

In a further example, by using the social network's 340 communication channels, a notification message may be transferred substantially in real time. The process of first handing a bill stating the purchase's money amount from merchant 325 to customer 305, then customer 305 confirming a respective money transfer via transaction application 330 and merchant 325 receiving the confirmation notification that the money of the respective bill has actually been transferred, only takes a few seconds, i.e., the payment of bills at a point of sales may thus substantially be performed in real time.

Thus, the intermediary based transaction system 300 provides a simplified but yet highly secure process of conducting payments at a local point of sales 325. After having installed the transaction application 330 on any computing device 310/320, for example a mobile phone 310, individual 305 may enter any local store 305 which may or may not be part of a social network 340.

In case the local store 325 is already a member of such virtual social network, a customer 305 just has to connect via the particular network's 340 connecting function to a virtual identity or the virtual entity of local store 325 to be able to transfer money using transaction application 330 to that merchant 325. In that case, merchant 325 receives a notification via the trusted communication channels of the social network 340 as a personal message prompting that a particular individual 305 (potentially with the individual' 305 current GPS location) has transferred a specific amount of money (namely the current amount to be paid at the cashier of merchant 325) with reference to a specific transaction (namely the current purchase).

Thus, within a few seconds and substantially in real time, local shop owner 325 will be notified that the customer 305 has just paid the outstanding bill and thus can immediately hand out the purchase to individual 305. This purchase can similarly be performed whether or not merchant 325 has been registered with payment provider 332 or not. In case, merchant 325 has not yet been registered with payment provider 332 as outlined above, the payment notification would, in one example, contain additional information for example a link that leads the merchant 325 to some registration procedure. This would allow merchants to quickly confirm a new account with payment provider 332 and thus establish access to the account that the payment of individual 305 has been credited to.

As indicated above, this process of payment using transaction application 330 is very simple, takes only a few seconds and may be confirmed substantially in real time. In addition, besides this obvious convenience, the process further significantly increases privacy and security of such transactions at a point of sales 325. More particularly, as the money transfer notification is generated substantially in real time at the point of sales 325 at the point in time when the purchase has to be paid, the generating of any fraudulent fake messages that would indicate such money transfer (without actually representing one) are prevented.

As a further level of security, the notifications are transmitted using the trusted communication channels of social networks 340, thus, there is substantially reduced likelihood for any third party to intercept the process. Even further, the trusted transaction provider 330 adds a further level of trust to the transaction, as it may act as a guarantor in the transaction for both sides, i.e., guaranteeing to merchant 325 that the amount of money notified is actually received at the merchant's 325 end and guaranteeing to user 305 that the money that is transferred from the account of user 305 is actually transferred to merchant 325.

Based on that, the merchant 325 is protected in terms that merchant 325 may not fear to encounter fraudulent use of means of payment, for example bogus money or fake credit cards, whereas user 305 is protected to encounter any fraudulent use of its financial identity in terms of banking account details, credit card information and the like.

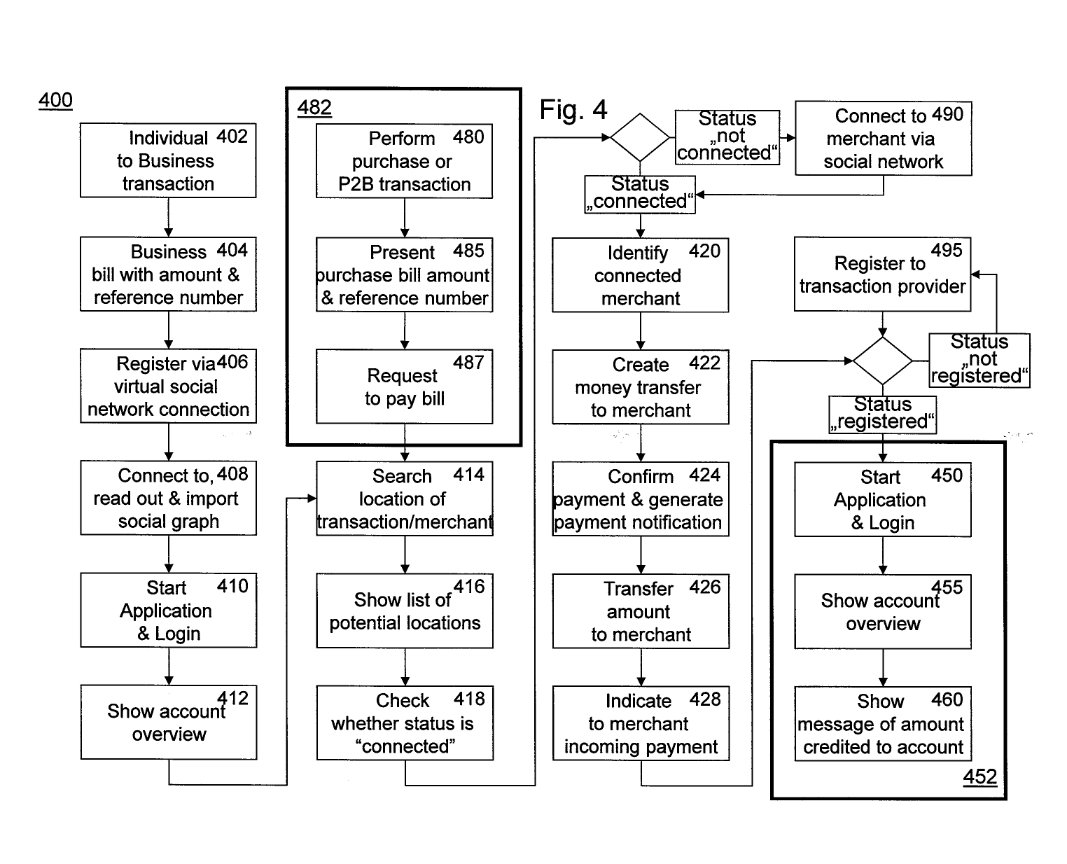

FIG. 4 shows a further exemplary sequence diagram illustrating examples of procedures performed with a transaction system 300.

The sequence depicted in FIG. 4 shows an individual-to-business transaction 400 that is conducted by an individual 305 in interaction with a business partner 325. More particularly, in step 402 of FIG. 4, an individual-to-business transaction is initiated. This step may comprise any real-life transaction like, for example, a purchase in a local store or any other form of transaction and/or purchase. Thus, the business transaction itself may be performed in a real-life environment at a local store 325 but may also be performed as a virtual transaction, for example via the internet, or any other form of transaction platform.

One example of such transaction is illustrated in the sequence of FIG. 4 by transaction 482. This transaction starts with the performing of a purchase or any other form of a private-to-business transaction 480. In response to that purchase or private-to-business transaction 480, merchant 325 presents individuals 305 a bill that shows the amount to be paid and may or may not show a reference number to identify the respective bill in step 485. Merchant 325 will, in response to presenting such bill, request to have the bill paid in step 487. At that point, a transaction 480 between an individual 305 and a merchant 325 has been performed and resulted in a bill presented to individual 305 and requested to be paid.

The presented bill with a bill amount and bill reference number may, in step 404, thus be the basis for the payment process initiated by individual 305 using transaction application 330. To use transaction application 330, individual 305 has previously, or at the moment ofpayment, registered to transaction provider 332 using any social network 340 in step 406 of FIG. 4. In response to registering with transaction provider 332, individual 305 engages and authorizes transaction application 330 to connect to, read-out and thus import the social graph 344 that is represented by individual's 305 account or virtual entity in virtual social network 340.

While in the sequence 400, shown in FIG. 4, the steps of registering 406 and importing the social graph 408 are illustrated as part of the payment process, these steps may also be performed as preparatory activities which are not necessarily performed in sequence, as highlighted in FIG. 4, and in close context of the payment process. In contrast, these activities may be performed at a different point in time and in varying sequences. More particularly, any of the steps 406/408 may have been performed previously. Thus, at the moment of payment, individual 305 may be able to login and use transaction application 330 on the basis of a previously performed registration 406 and importing 408 of social graph 344.

For performing the payment of the presented bill, individual 305 starts transaction application 330 on any mobile device 310/320 available or accessible to the individual 305. After the starting up and login procedure in step 412, individual 305 is, in the example of FIG. 4 by application 330, presented with an account overview that informs individual 105 about the available amount of money that can be transferred using transaction application 330. However, in other embodiments, after having studied and logged into transaction application 330, individual 305 may also be presented with alternative views provided by transaction provider 332.

In order to pay the bill presented by merchant 325, individual 305 will now, in step 440, use the transaction application 330 to search locations of transaction partners and/or merchants 325. For this search, individual 305 my use the virtual social network platform 340, for example by performing a key word and/or name search to identify the transaction partner 325. In addition and/or alternatively, individual 305 may in step 414 search for merchant 325 using the individual's 305 address book and/or favorites stored in transaction application 330. In other examples, individual 305 may also use positioning capabilities of mobile device 310/320 to make use of location based services provided by transaction application 330. In that example, the geoposition of individual 305 may be estimated using, for example, a global positioning system (GPS) signal, thus identifying the geoposition of individual 305 using positioning capabilities as built in device 310. In response to this positioning, the geoposition may be linked to additional information available to transaction application 330 like, for example, city maps, points of interest, merchant locations, and the like. Alternatively, or in addition, the geoposition may also be used by virtual social network platform 340 to further support and narrow down the list of locations identified using a key word search of individual 305 to identify merchant 325.

In response to the search performed in step 414 by any of the means described above, a list of potential locations is created in step 416 that relate to the search performed and shows at least one location 325 matching the criteria used by individual 305 for performing this search. In response to identifying merchant 325 in the list created in step 416 by individual 305, in step 418 a status of the identified merchant 325, in relation to individual 305 is tracked. More particular, in step 418, individual 305, by using transaction application 330, checks whether merchant 325 is already part of individual's 305 social graph 344 that has been previously imported in step 408 from a social network 340. In other words, in step 418, via transaction application 330, or alternatively using for example, virtual social network platform 340, individual 305 checks whether there is a social graph connection established between individual 305 and merchant 325 and whether this connection has already been imported to transaction application 330.

In case the status is found to be, or indicated as, “not connected”, this indicates that there is no social graph connection between individual 305 and merchant 325 imported to transaction application 330. Thus, in this case, in step 490, individual 305 connects to merchant 325 or rather the virtual identity of merchant 325 in virtual social network platform 340. Thus, either previously or at the moment of payment, individual 305 has connected to merchant 325 in a social graph 344, such that before step 420 of FIG. 4, the status is indicated as “connected”.

Accordingly, from the identified list of potential locations, or rather merchants 325 in step 416, individual 305 can identify the merchant 325 as connected in step 420. Based on that connection, individual 305 may use transaction application 330 to create a money transfer to merchant 325 in step 422. For that, individual 305, in one example uses functionality 240 of transaction application 230 to create and confirm a payment which results in generating a payment notification in step 424.

For creating such payment, in one example, individual 305 creates a money transfer transaction, in transaction application 330, which identifies a target which is in the example of FIG. 4, identified as the connected merchant 325. Moreover, this transaction will identify an amount of money to be transferred that may for example be manually entered by individual 305 in transaction application 330. In alternative embodiments this amount may be indicated to transaction application 330 via some means of near-field communication (NFC) at the cashier of merchant 325 that links to transaction application 330 executing on mobile device 310, like for example a Bluetooth interface at the cashier of the point of sales 325, and/or a near field communication reader at the retail cash register of merchant 325 that engages in a wireless communication with an NFC chip in mobile device 310.

In some embodiments, the payment generated in transaction application 330 will further show an identifying text that may, for example, consist of a message text manually entered by individual 305 and/or the reference number identified on the bill presented by merchant 325 in step 485. After having entered the necessary information to the money transfer, individual 305 confirms the transfer transaction and thus sends the entered amount to merchant 325 in step 426, using transaction application 330 and the money transfer services of transaction provider 332.

In response to that transfer in step 426, transaction provider 332 will trigger the virtual social network platform 340 to generate a notification message to the virtual identity or entity of merchant 325 representing merchant 325 in virtual social network 340. As described above, transaction provider 332 triggers virtual social network platform 340 such that the respective notification is generated using the trusted communication channels of platform 340 therefore the notification via platform 340 may be transmitted to merchant 325 substantially in real time.

Thus, in step 428, merchant 325 is presented with a notification that indicates to the merchants an incoming payment that may reference the bill presented in step 485 on the basis of the bill's reference number, and indicate that the money transferred equals the bill amount as presented in step 485. This indication is presented in step 428 to merchant 325 in any case, i.e., whether or not merchant 325 is registered with transaction provider 332.

In case merchant 325 has not yet been registered with transaction provider 332, this notification transmitted via platform 340 to merchant 325 in step 428 may additionally comprise a link, or other indications, to support merchant 325 in registering with transaction provider 332 in step 495. Similar to the individual's 305 registration step 406, also merchant 325 will register in step 495 with transaction provider 332 using virtual social network platform 340 associating an account of merchant 325 registered with transaction provider 332 with merchant's 325 virtual identity of accounts in virtual social network 340.

In case merchant 325 has registered with transaction provider 332, after having started transaction application 335 and login at step 450, merchant 325 may be presented with an overview of merchant's 325 account at transaction provider 332 in step 455. As indicated above, after starting and logging into transaction application 335 in step 450, merchant 325 may in other examples be presented with a different view. However, using transaction application's 230 functionality 255, merchant 325 may identify a balance representing the current status of the account of merchant 325. This account overview in step 460 shows a message of the amount that has been credited to merchant's 325 account by transaction provider 330.

As indicated in FIG. 4 however, the sequence of operating transaction application 335 at the end of merchant 325 as indicated via numeral 452, is optional for the case of merchant 325 also being registered with transaction provider 332. Using the sequence of steps 402 to 428, individual 305 may also transfer money to merchant 325 without merchant 325 being registered to transaction provider 332.

The fulfillment of the money transfer enabled by sequence 400 is done by transaction provider 332 initiating a money transfer from financial service provider 350 to transaction provider 332 and further from transaction provider 332 to financial service provider 355 as indicated in FIG. 3. In that example, individual 305 may hold a bank account at bank 350 or may possess a credit card of credit card issuer 350 and the like.

The money transfer from financial service provider 350 to transaction provider 332 may be performed using means of a bank transfer or alternatively a credit card booking or other means of financial services. However, alternatively, individual 305 may also create a virtual wallet, i.e., an e-wallet, at a transaction provider 332. In that case, individual 305 may transfer money from financial service provider 350 to transaction provider 332 in advance of any transaction or purchase as indicated in sequence 400. Thus, money transfers from financial service provider 350 to transaction provider 332, and further from transaction provider 332 to financial service provider 355, do not necessarily have to be synchronized and being performed in a strict sequence as indicated in FIG. 3. In contrast, a money transfer from transaction provider 332 to financial service provider 355, maintaining for example a bank account of merchant 325, may be performed by transaction provider 332 transferring money from an e-wallet of individual 305, the e-wallet having been loaded previously by an initial money transfer of individual 305, thereby decreasing the account balance of such e-wallet of individual 305.

In one example, for creating and pre-loading the e-wallet at transaction provider 332, the role of financial service provider 350 may also be taken over by merchant 325. In that example, instead of having a financial service provider 350 as an issuer of a means of payment, e.g., a credit card, somewhere in the chain of transactions, a closed loop of transactions can established by individual 305 and merchant 325 registering with transaction provider 332, individual 305 not only paying a purchase at merchant 325 but in addition paying in money to the e-wallet of individual 305 at the cashier of merchant 325.

In that example, merchant 325 not only acts as a point of sales 325 but in addition acts similar as an ATM, an ATM of transaction system 300. As financial service provider 350 is omitted in this closed loop transaction system 300 also any banking fee is omitted such that any money transfer that way may be conducted at substantially lower costs. Moreover, with potentially any merchant 325 being enabled to act as an ATM of system 300—as long as merchant 325 is registered with transaction provider 332—individual 305 will be provided with a rather unlimited number of terminals where they may pay in or take of money in cash.

In one example, the closed loop system further allows for omitting even the fulfillment of individual money transfers as merchant 325 and transaction provider 332 may balance out their accounts not on the basis of individual transactions (e.g., individual purchases) but on the basis of time-based restoring of account balances.

In that example, at the end of a defined period of time, for example at the end of each business day, an account balance is created between any merchant 325 and transaction provider 332 that balances out the sum of purchases to be paid, money taken out by individuals 305 at merchant 325, money paid in by individuals 305 at merchant 325 etc. such that the account balance between transaction provider 332 and merchant 325 is restored with just one single financial transaction per time period, e.g., business day—that way dramatically reducing any financial services fees within closed loop transaction system 300. Thus, based on closed loop transaction system 300 individuals 305 are provided with a rather unlimited number of service point 325 where individuals 325 may conduct money transfers in a “walk by” manner at a fraction of the traditional costs.

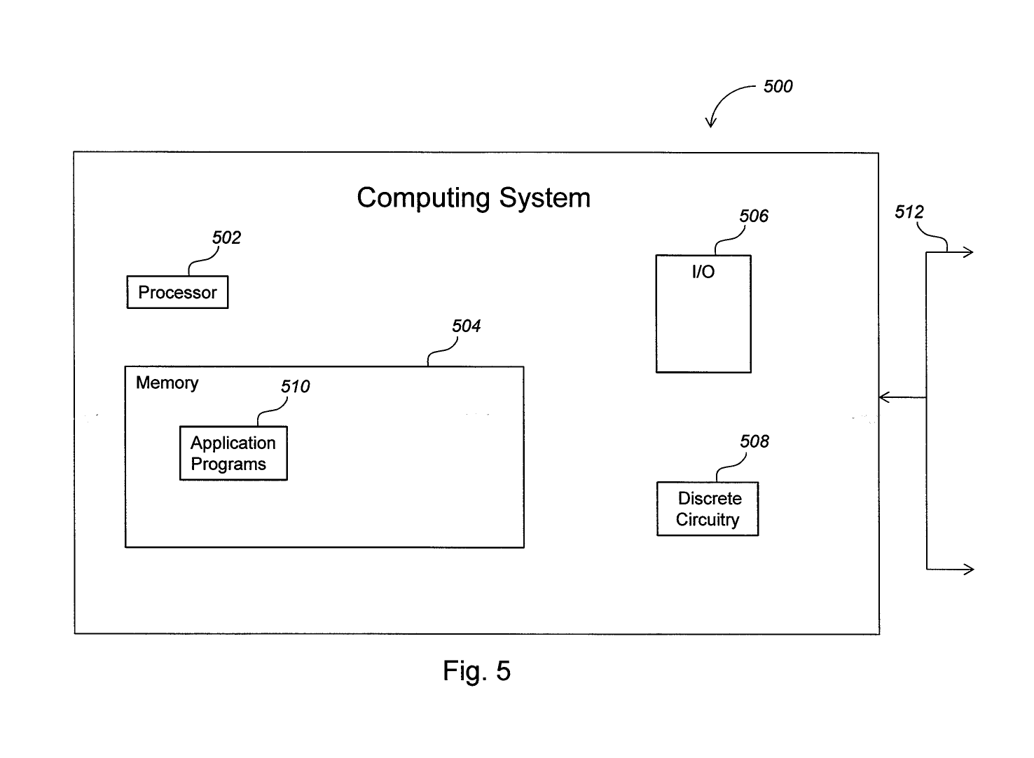

FIG. 5 is a block diagram illustrating a computing system 500 suitable for use in an embodiment of an intermediary-based transaction system. The computing system 500 comprises one or more processors 502, one or more memories 504, an input/output system 506, and discrete circuitry 508. One or more application programs 510 may be stored in the memory 504 and executed by the processor 502 to provide various desired functionality. As illustrated, the computing system 500 is communicatively coupled to a network 512. The computing system 500 may be employed to provide the functionality of the various components of an intermediary-based transaction system. For example, the system 500 may be employed to implement embodiments of a computing device (see device 110/120 in FIG. 1), a social network platform (see social network platform 140 of FIG. 1 and 340 of FIG. 3), a virtual transaction provider (see virtual transaction provider 132 of FIG. 1 and 332 of FIG. 3), etc.

All of the US patents, US patent application publications, US patent applications, foreign patents, foreign patent application and non patent publications referred to in this specification and/or listed in the application data sheet are incorporated herein by reference in their entirety.

From the forgoing and further it will be appreciated that, although specific embodiments have been described herein for purposes of illustration, various modifications may be made without deviating from the sprit and scope of the present disclosure. For example, the methods, techniques, computer-readable medium, and systems for providing intermediary based transactions discussed herein are applicable to other architectures and other system architectures depicted. Also, the methods, techniques, computer program products, and systems discussed herein are applicable to differing protocols, communication media (optical, wireless, cable, etc.) and devices (such as wireless handset, electronic organizers, personal digital assistants, portable email machines, game machines, pagers, navigating devices such as GPS receivers etc.).

Some embodiments may take the form of or comprise computer program products. For example, according to one embodiment there is provided a computer readable medium comprising a computer program adapted to perform one or more of the methods or functions described above. The medium may be a non-transitory medium such as a physical storage medium, for example, a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the systems and/or modules may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., programmed by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An intermediary-based, computer-implemented transaction-system for conducting transactions between entities connected via a social graph of a virtual social network, the system comprising:
at least one virtual social network platform storing social graphs connecting virtual entities of individuals and business partners, the virtual social network providing at least one virtual communication channel allowing any of the virtual entities to communicate with each other;
at least one social graph stored at the virtual social platform comprising a connection between at least one individual and at least one business partner;
a transaction provider configured to read-out the social graph and register the connection; and
one or more mobile devices configured to execute a transaction application provided by the transaction provider, the transaction application employing the registered connection to enable the at least one individual to create a transaction to the business partner using the transaction application such that a notification indicating the transaction is generated and transmitted to the business partner by triggering the at least one virtual communication channel.

2. The system of claim 1 wherein the notification is transmitted substantially in real time.

3. The system of claim 1 wherein the mobile device is at least one of a smart phone, a laptop, a tablet, pad, or a desktop computer.

4. The system of claim 1 wherein the business partner is a merchant at a local point of sale.

5. The system of claim 1 wherein the business partner is another individual.

6. The system of claim 1 wherein the reading-out of the social graph comprises connecting by the transaction application to the virtual social network using the individual's login to the virtual social network, reading-out the social graph of the individual, and importing all connections represented with the read-out social graph.

7. The system of claim 4 wherein the transaction application employs a positioning capability of the mobile device to enable the individual to identify the merchant using a location based service of the transaction provider.

8. The system of claim 4 wherein after registering with the transaction service provider the mobile device is configured to employ a positioning capability of the mobile device to identify the merchant using a location based service without the transaction application being executed on the mobile device at the moment of identifying.

9. A computer-implemented, intermediary-based method for conducting transactions between entities connected via a social graph of a virtual social network, the method comprising:
storing in at least one virtual social network platform at least one social graph connecting virtual entities of individuals and business partners, the virtual social network providing at least one virtual communication channel allowing any of the virtual entities to communicate with each other;
storing with the at least one social graph at least one connection between at least one individual and at least one business partner;
reading-out and registering the at least one connection by a transaction provider; and
employing the registered connection to enable the at least one individual to create a transaction to the business partner by using a transaction application executing on a mobile device such that a notification indicating the transaction is generated and transmitted to the business partner by triggering the at least one virtual communication channel, wherein the storing, the reading-out and the employing are performed by one or more configured computing systems.

10. The method of claim 9 wherein the notification is transmitted substantially in real time.

11. The method of claim 9 wherein the mobile device is at least one of a smart phone, a laptop, a tablet, pad, or a desktop computer.

12. The method of claim 9 wherein the business partner is a merchant at a local point of sale.

13. The method of any of claim 9 wherein the business partner is a further individual.

14. The method of claim 9 wherein the act of reading-out comprises connecting by the transaction application to the virtual social network using the individual's login to the virtual social network, reading-out the social graph of the individual, and importing all connections represented with the read-out social graph.

15. The method of claim 12, further comprising employing by the transaction application a positioning capability of the mobile device to enable the individual to identify the merchant using a location based service of the transaction provider.

16. The method of claim 12 wherein after registering with the transaction service provider the mobile device is enabled for employing a positioning capability of the mobile device to identify the merchant using a location based service without the transaction application being executed on the mobile device at the moment of identifying.

17. A non-transitory computer-readable medium whose contents configure a computing system to perform a method, the method comprising:
storing in at least one virtual social network platform at least one social graph connecting virtual entities of individuals and business partners, the virtual social network providing at least one virtual communication channel allowing any of the virtual entities to communicate with each other;
storing with the at least one social graph at least one connection between at least one individual and at least one business partner;
reading-out and registering the at least one connection by a transaction provider; and
employing the registered connection to enable the at least one individual to create a transaction to the business partner by using a transaction application executing on a mobile device such that a notification indicating the transaction is generated and transmitted to the business partner by triggering the at least one virtual communication channel.

18. The computer-readable medium of claim 17 wherein the business partner is a merchant at a local point of sale.

19. The computer-readable medium of claim 17 wherein the reading-out comprises connecting by the transaction application to the virtual social network using the individual's login to the virtual social network, reading-out the social graph of the individual, and importing all connections represented with the read-out social graph.

20. The computer-readable medium of claim 17 wherein after registering with the transaction service provider the mobile device is enabled for employing a positioning capability of the mobile device to identify the merchant using a location based service without the transaction application being executed on the mobile device at the moment of identifying.
